(19) United States
(12) Patent Application Publication
(10) Pub. No.: US 2015/0278342 A1
(43) Pub. Date: Oct. 1, 2015

(54) APPARATUS AND METHOD FOR RECOMMENDING SERVICE

(71) Applicant: Electronics and Telecommunications Research Institute, Daejeon (KR)

(72) Inventors: Si-Hwan JANG, Daejeon (KR); Sang-Hyun JOO, Daejeon (KR); Ji-Won LEE, Daejeon (KR); Jae-Sook CHEONG, Daejeon (KR)

(21) Appl. No.: 14/668,073

(22) Filed: Mar. 25, 2015

(30) Foreign Application Priority Data
Mar. 25, 2014 (KR) 10-2014-0034388
Mar. 25, 2014 (KR) 10-2014-0034391
Mar. 25, 2014 (KR) 10-2014-0034395
Mar. 9, 2015 (KR) 10-2015-0032779
Mar. 9, 2015 (KR) 10-2015-0032783
Mar. 9, 2015 (KR) 10-2015-0032785

(51) Int. Cl. G06F 17/30

(52) U.S. Cl. CPC G06F 17/30598; G06F 17/30312

(57) ABSTRACT

An apparatus for recommending a service in accordance with an embodiment of the present invention includes: a user description providing unit configured for storing a user description; a communication interface configured for receiving a request for recommendation of a service; and a recommendation engine configured for obtaining the user description corresponding to the request for recommendation of a service from the user description providing unit and generating a recommendation description by referring to the user description,

### CROSS-REFERENCE TO RELATED APPLICATIONS

This application claims the benefit of Korean Provisional Patent Application Nos. 10-2014-0034388, 10-2014-0034395 and 10-2014-0034391 filed with the Korean Intellectual Property Office on Mar. 25, 2014, and Korean Patent Application Nos. 10-2015-0032779, 10-2015-0032783 and 10-2015-0032785 filed with the Korean Intellectual Property Office on Mar. 9, 2015, the disclosure of which is incorporated herein by reference in their entirety.

### BACKGROUND

1. Technical Field

The present invention relates to recommending a service by use of a user description, more specifically to providing a recommendation description for providing a service suitable for a user through a user description.

2. Background Art

As a vast amount of data has become easily accessible owing to the advancement of the Internet and network technologies, customized analyses of expanded data, such as big data, have been risen to a new issue. That is, rather than accessing the data itself, selecting and supplying valuable data for each individual's purpose has become more important for the differentiation of a service. Exposure to a large amount of data is rather less preferred, and providing higher quality data at a right time at a right place secures a greater number loyal users. In order to differentiate the service among a countlessly large number of similar services, the service needs to be customized by analyzing a variety of contexts of users.

### SUMMARY

The present invention provides an apparatus and a method for recommending a service that can provide a recommendation description in order to provide a service customized for a user by use of a user description.

An aspect of the present invention provides an apparatus for recommending a service, which includes: a user description providing unit configured for storing a user description; a communication interface configured for receiving a request for recommendation of a service; and a recommendation engine configured for obtaining the user description corresponding to the request for recommendation of a service from the user description providing unit and generating a recommendation description by referring to the user description, wherein the user description includes at least one of UserProfileType, PersonProfileType, OrganizationProfileType, DeviceProfileType, GroupedProfileType, UsageHistoryTyp, EventType, interactionAtomType, artefactType, observableType, stateType, PreferenceType, EmotionType, VocabularySetType, ScheduleType, ActivityType, IntentionType, LanguageType, SpecialtyType, AccessibilityType, SocialInformationType and ObjectSharingType.

The UsageHistoryType may include multimediaExperienceType and DetailedUserInteractionType.

The PreferenceType may include at least one of AudioPresentationPreferencesType, DisplayPresentationPreferencesType, GraphicsPresentationPreferencesType, ServicePreferenceType, AudioPresentationPreferencesInfoType, TranslationPreferenceType, InterestedMediaType and WebLinkPreferencesType.

The LanguageType may include at least one of NameType, CompetenceReferenceType, LanguageRegionType, Type, ReadingLevelType, WritingLevelType, SpeakingLevelType and ListeningLevelType.

The CompetenceReferenceType may include CompetenceTestNameType, CompetenceLevelType, CompetenceTestURIType and CompetenceTestDateType.

The ScheduleType may include EventType, wherein the EventType may include at least one of SharedUser, RecurrenceInfoType, AlarmTimeType, AlarmFormatType and descriptionMethodType.

The apparatus for recommending a service may further include a service description providing unit configured for storing a service description, wherein the recommendation engine is configured for generating the recommendation description by referring to the service description and the user description corresponding to the request for recommendation of a service, and wherein the service description may include at least one of Service General Description, FormatType, ServiceTargetInformationType, ServiceTargetModelType, VocabularySetType, ServiceInterfaceType, RequiredInputDataType, InternalServicesType, InternalServiceType, LosslessAudioDBType, LossyAudioDBType, VideoDBType, ServiceObjectType and ObjectType.

The apparatus for recommending a service may further include a context description providing unit configured for storing a context description, wherein the recommendation engine is configured for generating the recommendation description by referring to the context description and the user description corresponding to the request for recommendation of a service, and wherein the context description may include at least one of ContextDescriptionType, ContextIdentificationType, DeviceCharacteristicsType, NewworkInfoType, LocationType, WeatherType, OtherEnvironmentalInfoType, AudioEnvironment, RecordingEnvironmentType and ContextPriorityType.

Another aspect of the present invention provides a method for recommending a service, the service being recommended by an apparatus for recommending a service. The method for recommending a service in accordance with an embodiment of the present invention includes: receiving a request for recommendation of a service; obtaining a user description corresponding to the request for recommendation of a service; and generating a recommendation description by referring to the user description, wherein the user description may include at least one of UserProfileType, PersonProfileType, OrganizationProfileType, DeviceProfileType, GroupedProfileType, UsageHistoryTyp, EventType, interactionAtomType, artefactType, observableType, stateType, PreferenceType, EmotionType, VocabularySetType, ScheduleType, ActivityType, IntentionType, LanguageType, SpecialtyType, AccessibilityType, SocialInformationType and ObjectSharingType.

The UsageHistoryType may include multimediaExperienceType and DetailedUserInteractionType.

The PreferenceType may include at least one of AudioPresentationPreferencesType, DisplayPresentationPreferencesType, GraphicsPresentationPreferencesType, ServicePreferenceType, AudioPresentationPreferencesInfoType, TranslationPreferenceType, InterestedMediaType and WebLinkPreferencesType.

The LanguageType may include at least one of NameType, CompetenceReferenceType, LanguageRegionType, Type, ReadingLevelType, WritingLevelType, SpeakingLevelType and ListeningLevelType.

The CompetenceReferenceType may include CompetenceTestNameType, CompetenceLevelType, CompetenceTestURIType and CompetenceTestDateType.

The ScheduleType may include EventType, wherein the EventType may include at least one of SharedUser, RecurrenceInfoType, AlarmTimeType, AlarmFormatType and descriptionMethodType.

The method for recommending a service may further include obtaining a service description corresponding to the request for recommendation of a service, wherein in the generating of the recommendation description by referring to the user description, the recommendation description is generated by referring to the user description and the service description, wherein the service description may include at least one of Service General Description, FormatType, ServiceTargetInformationType, ServiceTargetModelType, VocabularySetType, ServiceInterfaceType, RequiredInputDataType, InternalServicesType, InternalServiceType, LosslessAudioDBType, LossyAudioDBType, VideoDBType, ServiceObjectType and ObjectType.

The method for recommending a service may further include obtaining a context description corresponding to the request for recommendation of a service, wherein in the generating of the recommendation description by referring to the user description, the recommendation description is generated by referring to the user description and the context description, and wherein the context description may include at least one of ContextDescriptionType, ContextIdentificationType, DeviceCharacteristicsType, NewworkInfoType, LocationType, WeatherType, OtherEnvironmentalInfoType, AudioEnvironment, RecordingEnvironmentType and ContextPriorityType.

### BRIEF DESCRIPTION OF DRAWINGS

FIG. 1 is a block diagram showing an apparatus for recommending a service in accordance with an embodiment of the present invention.

FIG. 2 is a flow diagram showing how the apparatus for recommending a service recommends a service in accordance with an embodiment of the present invention.

FIG. 3 illustrates a computer system implemented with the apparatus for recommending a service in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

When one element is described to “send” or “transmit” a signal to another element, it shall be construed that the signal is sent or transmitted to the other element by having the one element directly connected to the other element but also by, unless explicitly described otherwise, possibly having another element interposed between the one element and the other element.

FIG. 1 is a block diagram showing an apparatus for recommending a service in accordance with an embodiment of the present invention.

Referring to FIG. 1, an apparatus 100 for recommending a service in accordance with an embodiment of the present invention includes a communication interface 110, a recommendation engine 120, a user description providing unit 130, a service description providing unit 140 and a context description providing unit 150.

The communication interface 110 is connected with a service providing apparatus 50 through a communication network to receive a request for recommendation of a service from the service providing apparatus 50 and send the request to the recommendation engine 120. Here, the request for recommendation of a service may include an identification information of a user who will receive the service.

Moreover, upon receiving a recommendation description from the recommendation engine 120, the communication interface 110 transmits the recommendation description to the service providing apparatus 50, which is an apparatus that provides a specific service to the user. For example, the service providing apparatus 50 may be any device, such as a user terminal or a server providing a service to the user terminal, which is connected with the communication interface 110 through a communication network.

Upon receiving the request for recommendation of a service, the recommendation engine 120 generates a recommendation description used for providing a service suitable for the user. The recommendation engine 120 obtains a user description from the user description providing unit 130, a service description from the service description providing unit and a context description from the context description providing unit 150. The recommendation engine 120 analyzes the obtained user description, service description and context description according to a predetermined pattern and generates the recommendation description. The recommendation description is a set of recommended information elements provided to applications in a structural, efficient, compact fashion when a customer requests for a service in a specific environment. The recommendation description may include information extracted from the user description, context description and service description, information indicating a logical relation between the user/context/service descriptions and metadata. The recommendation engine 120 that generates the recommendation description may have various ranges of complexity and performance. The recommendation description may have a general format that is independent from applications. Here, the recommendation engine 120 may generate the recommendation description according to a pattern known through, for example, the MPEG-UP standard. The recommendation engine 120 transmits the recommendation description to the service providing apparatus 50 through the communication interface 110.

The user description providing unit 130 stores the user description and provides the description to the recommendation engine 120. For example, the recommendation engine 120 sends a request for user description, including the identification information of the user, to the user description providing unit 130, and the user description providing unit 130 sends the user description corresponding to the identification information of the user to the recommendation engine 120.

The user description includes UserProfileType, PersonProfileType, OrganizationProfileType, DeviceProfileType, GroupedProfileType, UsageHistoryTyp, EventType, interactionAtomType, artefactType, observableType, multimediaExperienceType, stateType, PreferenceType, WebLinkPreferenceType, ServicePreferencesType, AudioPresentationPreferencesInfoType, TranslationPreferencesType, EmotionType, VocabularySetType, EmotionGroupType, ScheduleType, ScheduleEventType, ActivityType, IntentionType, LanguageType, LanguageCompetenceReferenceType, CompetenceLevelType, SpecialtyType, AccessibilityType, SocialInformationType and ObjectSharingType.

The UserProfileType describes basic entity information of the user. The semantics of the UserProfileType is shown in Table 1 below.

TABLE 1

| Name | Definition |
|---|---|
| Specialty | Describes a specialty that this group has in |
| | various fields |

The PersonProfileType describes a person entity. The PersonProfileType can be used to describe individual basic properties of human being. The semantics of PersonProfileType are shown in Table 2 below.

TABLE 2

| Name | Definition |
|---|---|
| PersonInformationType | Describes basic personal information, including |
| | sex, name, height, weight, blood type, etc. |
| BirthtimeType | Describes the birthtime. |
| Language Type | Describe properties of a specific language that |
| | this user can use. May be the native language |
| | of the user and other available source language. |
| Accessibility | Describes the characteristics of a particular |
| | user's disability, such as visual, hearing, |
| | physical, intellectual or other impairment. |
| ReleationshipStatusType | Describes the relationship status of the user. |
| SocialInformationType | Describes information on the social |
| | communities of the user for describing how |
| | the user shares his object with those with a |
| | social relationship. |

The semantics of the OrganizationProfileType is shown in Table 3 below.

TABLE 3

| Name | Definition |
|---|---|
| OrganizationInformationType | Describes the information of user's |
| | organization |

The DeviceProfileType includes various information on the user device. The semantics of the DeviceProfileType are shown in Table 4 below.

TABLE 4

| Name | Definition |
|---|---|
| DeviceType | Description of the device |
| | capabilities |
| DeviceCategoryType | Describes the category of device |
| | among predesignated categories. |
| DeviceIDType | Description of the device |
| | identifier |

The GroupedProfileType can be used to describe basic attributes of a group which is a set of users. The semantics of the GroupedProfileType are shown in Table 5 below.

TABLE 5

| Name | Definition |
|---|---|
| UserType | Describes information of a |
| | group's member, (i.e. User Profile, Device |
| | Profile, Organization Profile) |
| UserRefType | Describes the reference of a |
| | group's member as anyURI |

The UsageHistoryType describes the history of actions on specific area by a user, including usage history of media contents, movement of user, pattern in online social network. etc. The semantics of the UsageHistoryType are shown in Table 6 below.

TABLE 6

| Name | Definition |
|---|---|
| MultimediaExperiencesType | Describes the user's multimedia |
| | experience, for example, multimedia |
| | played back by the user in the past. |
| DetailedUserInteractionType | Structure containing information |
| | about the multimedia experiences of the |
| | user |

The EventType describes information on an event. The semantics of the EventType are shown in Table 7 below.

TABLE 7

| Name | Definition |
|---|---|
| startTimeType | The start time of the event |
| endTimeType | The end time of the event |
| CoordinatesType | The geolocalization of the event |

The interactionAtomType describes observables and artefacts. The semantics of the interactionAtomType are shown in Table 8 below.

TABLE 8

| Name | Definition |
|---|---|
| RoleType | Expresses the functionality of an |
| | interaction atom (e.g. an observable or an |
| | artefact). For example, if the user adds a |
| | text part (artefact) with the intention of |
| | annotating an image (observable), the role |
| | of such text will be “annotation.” |
| MultimediaObjectType | Any type of data that can be |
| | handled by a device in order to produce |
| | multimedia contents. Multimedia objects |
| | may include the object types of Text, |
| | Image, Video, AudioVisual, Audio, |
| | Application. |
| CompositionType | Any composition of Artefacts or |
| | Observables |

The artefactType describes a specific multimedia object, e.g. tags, annotations, voice, generated or selected by the user while in a specific state.

The observableType describes a specific multimedia object that the user may decide to use. An observable may be any multimedia object visible to the user in a specific state (e.g. an image in the graphic interface). The semantics of the observableType is shown in Table 9 below.

TABLE 9

| Name | Definition |
|---|---|
| UsageEventType | Structure containing information |
| | about when the observable has been |
| | actually used by the user. A specific event |
| | which occurs every time the user decides |
| | to actually use an observable. |

The semantics of the multimediaExperienceType is shown in Table 10.

TABLE 10

| Name | Definition |
|---|---|
| StatesType | Describes the states that compose |
| | the multimedia experience |

Table 11 shows the semantics of the stateType.

TABLE 11

| Name | Definition |
|---|---|
| ArtefactsType | The artefacts characterizing the |
| | state |
| ObservablesType | The observables characterizing |
| | the state |
| SemanticallyRelatedStates | Structure pointing to semantically |
| | related states to the current state. |

The PreferenceType describes the preference related to the various services. Table 12 shows the semantics of the PreferenceType.

TABLE 12

| Name | Definition |
|---|---|
| UserPreferencesType | Describes the user's preferences |
| | pertaining to consumption of multimedia |
| | content, in particular, filtering, searching |
| | and browsing of multimedia content. |
| AudioPresentationPreferencesType | Describes the preferences of a |
| | User regarding the presentation or |
| | rendering or audio resources. May be |
| | defined with |
| | AudioPresentationPreferencesType |
| | defined according to The mpeg7 and |
| | mpeg21. |
| DisplayPresentationPreferencesType | Describes preferences of a User |
| | regarding the presentation or rendering of |
| | images and videos. May be defined with |
| | DisplayPresentationPreferencesType |
| | defined according to mpeg21. |
| GraphicsPresentationPreferencesType | Describes presentation |
| | preferences related to graphics media. |
| | May be defined with |
| | GraphicsPresentationPreferencesType |
| | defined according to mpeg21. |
| ServicePreferenceType | Describes the level of preferences |
| | for specific services. |
| AudioPresentationPreferencesInfoType | Describes the preferences of a |
| | User regarding the presentation or |
| | rendering or lossless audio resources. |
| TranslationPreferenceType | Describes the preferences for |
| | translation services. |
| InterestedMediaType | Describes the media of interest |
| WebLinkPreferencesType | Describes the preference related |
| | to the various weblinks. |

The semantics of the WebLinkPreferencesType are shown in Table 13 below.

TABLE 13

| Name | Definition |
|---|---|
| WebLinkAddressType | Describes the preference related |
| | to the specific weblink |
| preferenceLevelType | Describes a ranking of the weblink |
| | preference. For example, value ranges |
| | from 0 to 100 and default value is 50 |

Table 14 shows the semantics of the ServicePreferenceType.

TABLE 14

| Name | Definition |
|---|---|
| ServiceGeneralInformationType | Describes general information of |
| | the service, e.g., service name, |
| | provider name, generic service |
| | information, service URI, service |
| | category and so. |
| preferenceLevelType | Indicate the priority or weight |
| | assigned to a particular user |
| | preference. For example, the range |
| | of the preference values is from |
| | 0 to 100. |

The semantics of the AudioPresentationPreferencesInfoType are shown in Table 15.

TABLE 15

| Name | Definition |
|---|---|
| LosslessCreationInfoType | Describes user's preference on |
| | the creating information for lossless |
| | audio. |
| LosslessAudioFormatType | Describes user's preference on |
| | the format type for lossless audio. |
| LossyAudioFormatType | Describes user's preference on |
| | the format type for lossy audio. |
| LosslessAudioFileSizeType | Describes user's preference on |
| | the file size for lossless audio. |
| AudioMusicPreferenceType | Describes user's preference on |
| | the preference of music for audio. |

The semantics of the TranslationPreferencesType are shown in Table 16 below.

TABLE 16

| Name | Definition |
|---|---|
| SourceLanguagePreferenceType | Describes user's preference on |
| | the source language for translation. |
| TargetLanguagePreferenceType | Describes user's preference on |
| | the target language for translation. |
| SpeechStylePreferenceType | Describes user's preference on |
| | the style of the translated output |
| | speech. |
| VoiceGenderPreferenceType | Describes user's preference on |
| | the gender of the translated output |
| | speech. |
| VoicePitchType | Describes user's preference on |
| | the pitch of the translated output |
| | speech. |
| VoiceSpeedType | Describes user's preference on |
| | the speed of the translated output |
| | speech. |
| RequestVariantsType | Describes user's requirement for |
| | language variant. |

The EmotionType can be used to represents user's subjective notion and feeling. It can be described user's emotion including its changes over time. The emotion can be acquired by some direct input of user or inference results from sensor data. The semantics of the EmotionType are shown in Table 17.

TABLE 17

| Name | Definition |
|---|---|
| EmotionGroupType | Describes an emotion or some |
| | related information. The emotion |
| | is described by several |
| | EmotionDescription, each being |
| | present with different values |
| | of reliability. |
| DynamicEmotionVocabularySetType | Describes a dynamic set of |
| | emotion vocabularies. Only |
| | vocabulary names defined in the |
| | declared emotion vocabulary set |
| | of the given element can be used |
| | for representations of emotions. |
| StaticEmotionVocabularySetType | Describes a static set of emotion |
| | vocabularies. |
| | Other values that are datatype- |
| | valid with respect to |
| | mpeg7:termReferenceType are |
| | reserved. |

The DynamicEmotionVocabularySetType can include VocabularySetType to describe the fundamental emotions according to a set of definite criteria. The complete set of vocabularies for representing emotions does not exist. Therefore, the DynamicEmotionVocabularySetType can include vocabulary that can be temporarily used to define the set of emotion vocabularies.

The VocabularySetType can be used to describe the fundamental vocabularies according to a set of definite criteria. The semantics of the VocabularySetType are shown in Table 18.

TABLE 18

| Name | Definition |
|---|---|
| VocabularyType | Describes some information of each |
| | vocabulary which composes the |
| | emotionvocabularyset. |
| NameType | Describes the name of vocabulary |
| IdType | Describes the unique id of VocabularySet |

Moreover the user description includes EmotionGroupType. The EmotionGroupType can be used to describe and specify detailed information about emotion state of this user according to a specific duration. The semantics of the EmotionGroupType are shown in Table 19.

TABLE 19

| Name | Definition |
|---|---|
| PeriodOfOccurrenceType | Describes the starting and ending |
| | absolute times |
| EmotionDescriptionType | Describes the specific emotional |
| | state |
| emotionNameType | Denotes the name of emotion on |
| | the result of measuring a user's emotional |
| | state. The value of “name” must be one of |
| | the predefined vocabularies of emotion-set. |
| | For example, when it comes to defining |
| | “BigSix” as the value for “emotion-set” |
| | attribute of “Emotion Group” element, the |
| | only acceptable values are: [anger, disgust, |
| | fear, happiness, sadness, surprise](refer to |
| | the Bix6 theory made by Paul Ekman) |
| ValueType | Describes the level of emotion on |
| | the result of measuring a user's emotional |
| | state. This value can be described based on |
| | normalizedRatioValueType. |
| ReliabilityType | Describes the degree of reliability |
| | on the result of measuring a user's |
| | emotional state. The value of “reliability” |
| | must be a floating point number and cannot |
| | be lower than 0 or greater than 1. |
| triggeredBy | Describes who and what caused |
| | this emotion. The emotion can be triggered |
| | by such a vehicle as persons, animals and |
| | media. |
| detectedFrom | Describes the modality where an |
| | emotion is produced. Specific user emotion |
| | is usually detected through human's action |
| | and appearances such as face, gesture, |
| | voice, word, posture and |
| | EEG(electroencephalography). |
| aspectType | Describes the specific features of |
| | the trigger that causes the emotion. e.g. |
| | battery duration of the Smartphone |
| emotion-setType | Describes which emotion |
| | vocabularies set shall be used to describe |
| | several emotion descriptions. |

Moreover, the user description includes ScheduleType. The ScheduleType represents a plan for events related to the user. Table 20 show the semantics of the ScheduleType.

TABLE 20

| Name | Definition |
|---|---|
| EventType | Describes a specific scheduled |
| | event |

Table 21 shows the semantics of the ScheduleEventType.

TABLE 21

| Name | Definition |
|---|---|
| SharedUser | Indicates which users can share |
| | this schedule information. |
| RecurrenceInfoType | Describes recurrence cycle of an |
| | event. |
| AlarmTimeType | Describes the alarm time for |
| | scheduled event. |
| AlarmFormatType | Describes format of alarm such |
| | as visual object, audio object, video |
| | object, text object, image object. |
| descriptionMethodType | Describes the method how Mpeg- |
| | UD document can acquire this schedule |
| | information. |

The semantics of the AcitvityType are shown in Table 22 below.

TABLE 22

| Name | Definition |
|---|---|
| PeriodOfOccurrenceType | Describes a time point or interval |
| | of behaviors such as running, walking, |
| | drinking, watching and so on. |
| DescriptionType | Describes additional Information |
| | of this activity |
| ActivityItemType | Describes the activity which user |
| | did |
| MovingSpeedType | Describes the moving speed of |
| | user. (m/s) |
| OrientationType | Describes the orientation of the |
| | user |
| LocationType | Describes the location of the user |
| PhysicalStateType | Describes the physical state of |
| | user. |
| HeartbeatType | Indicates heartbeat of user |
| ECGType | Indicates ECG value of user |
| RespirationRateType | Indicates Respiration rate of user |
| BloodPressureType | Indicates blood pressure of user. |
| | (mmHg) |
| BloodSugarType | Indicates blood sugar of user. |
| | (mg/dl) |

The semantics of the IntentionType are shown in Table 23.

TABLE 23

| Name | Definition |
|---|---|
| IntentionObjectIDType | Describes ID of the object for |
| | user's intention. |
| IntentionObjectFormatType | Describes format of the object |
| | for user's intention such as visual object, |
| | audio object, video object, text object, |
| | image object. |
| IntentionActionType | Describes user's intention such |
| | as copy, paste, edit and so. |

The LanguageType can be used to describe properties of a specific language that this user can use. The semantics of the LanguageType are shown in Table 24 below.

TABLE 24

| Name | Definition |
|---|---|
| NameType | Indicates the name of the |
| | language in which this user can use |
| CompetenceReferenceType | Describes the competence of the |
| | user |
| LanguageRegionType | Describes the region of the |
| | language spoken. Ex. British English, |
| | South Korean |
| Type | Indicates The types of languages. |
| | The types of languages are defined as |
| | follows: (Native - This is the language |
| | that a person has spoken from earliest |
| | childhood; Foreign - This is any other |
| | languages except for the native |
| | language.) |
| ReadingLevelType | Describes the reading level of the |
| | user for the specific language |
| WritingLevelType | Describes the writing level of the |
| | user for the specific language |
| SpeakingLevelType | Describes the speaking level of |
| | the user for the specific language |
| ListeningLevelType | Describes the listening level of |
| | the user for the specific language |

LanguageCompetenceReferenceType describes user's competence for a specific language in the common test. The semantics of LanguageCompetenceReferenceType are shown in Table 25.

TABLE 25

| Name | Definition |
|---|---|
| CompetenceTestNameType | Provides the competence test |
| | name. Ex. TOEFL, IELTS |
| CompetenceLevelType | Provides the score or level of the |
| | competence test |
| CompetenceTestURIType | Provides the URI of the |
| | competence test. |
| | Ex.http://www.ets.org/toefl |
| CompetenceTestDateType | Provides the date of the |
| | competence test taken by the user |

The semantics of the CompetenceLevelType are shown in Table 26.

TABLE 26

| Name | Definition |
|---|---|
| FieldScoreType | Indicates the field of test score |
| maxScoreType | Indicates the max score of test |
| FieldLevelType | Score or level of the test field |
| CompetenceFieldType | Indicates the fields of |
| | competence test |

Moreover, the user description includes SpecialtyType. The SpecialtyType can be used to describe a value specific to a particular user. The semantics of the SpecialtyType are shown in Table 27.

TABLE 27

| Name | Definition |
|---|---|
| SpecialtyType | Describes a specialty that group |
| | has in various fields. |

The AccessibilityType can be used to describe the characteristics of a user's disabilitydisability. The semantics of the AccessibilityType are shown in Table 28.

TABLE 28

| Name | Definition |
|---|---|
| AuditoryImpairmentType | Describes the characteristics of a |
| | particular user's auditory |
| | disabilitydisability. The description |
| | can be used by the audio resource |
| | adaptation engine. |
| VisualImpairmentType | Describes the characteristics of a |
| | particular user's visual impairment. |
| | Visual Impairment covers a wide range |
| | of conditions. The various forms of |
| | visual impairment include difficulty |
| | to read the fine print, low vision |
| | that cannot be corrected by standard |
| | glasses, total blindness, color |
| | vision disability |
| BodyImpairmentTypeType | Describes the characteristics of a |
| | user's body disability. May include |
| | AvailabelFingerType, which indicates |
| | the number of available fingers, |
| | ArmType, which indicates the |
| | disability of arms, and LegType, |
| | which indicates the disability of |
| | legs. |
| LightSensitivityTypeType | Describes the user's Light- |
| | Sensitivity. May include minBlinkType, |
| | which indicates minimum number of |
| | Blinks per second which would cause |
| | any problem to the user, and |
| | maxBlinkType, which indicates |
| | maximum number of Blinks per second |
| | which would cause any problem to |
| | the user. |
| SexualContentAccessTypeType | Describes the user's preference |
| | on the access control over sexual |
| | content. |
| ViolenceTypeType | Describes the user's preference |
| | on the access control over contents |
| | with violence. |
| HorrorTypeType | Describes the user's preference |
| | on the access control over contents |
| | with horror scenes. |
| GamblingTypeType | Describes if the user allows access |
| | to the contents or services related |
| | to the gambling. |
| LevelTypeType | Describes the intensity of |
| | expression. May have values of none, |
| | low, middle and high. |
| SideType | Describes the specific side of |
| | body. May have values of both, left |
| | and right. |

SocialInformationType can be used to describe information on the social communities provided by a given service. The semantics of the SocialInformationType are shown in Table 29.

TABLE 29

| Name | Definition |
|---|---|
| ServiceIDType | Describes the service used by the |
| | user |
| LoginIDType | Describes the login ID of the |
| | user |
| LoginPasswordType | Describes the password |
| NicknameType | Describes the nickname of the |
| | user if any. |
| GroupIDType | Describes the group which the |
| | user belongs to |
| FriendUserIDType | Describes the list of friends |

The semantics of ObjectSharingType are shown in Table 30.

TABLE 30

| Name | Definition |
|---|---|
| ShareUserIDType | Describes the users that shares |
| | the object |
| ObjectIDType | Describes the ID of the object |
| OwnershipType | Describes the ownership of the |
| | object |
| ObjectAccessibilityType | Describes the way object is |
| | accessible. For example, the object may |
| | be open to a specific group, e.g., private, |
| | public, etc., or to everyone. |

The service description providing unit 140 stores the service description and provides the service description to the recommendation engine 120. For example, the recommendation engine 120 sends a request for service description to the service description providing unit 140, and the service description providing unit 140 sends the service description according to the request for service description to the recommendation engine 120. The service description may include information on which user is targeted for each service.

The service description includes Service General Description, FormatType, ServiceTargetInformationType, ServiceTargetModelType, VocabularySetType, ServiceInterfaceType, RequiredInputDataType, InternalServicesType, InternalServiceType, LosslessAudioDBType, LossyAudioDBType, VideoDBType, ServiceObjectType and ObjectType.

ServiceGeneralInformationType describes general information about service. The semantics of ServiceGeneralInformationType are shown in Table 31 below.

TABLE 31

| Name | Definition |
|---|---|
| ServiceName | Describes the name of the service. |
| ServiceProviderName | Describes the name of service provider. |
| Description | Describes service generic description. |
| ServiceURI | Describes URI to access information |
| | about the service. |
| ServiceCategory | Describes the service category using an |
| | MPEG-7 Classification Scheme. |
| | Terms for the ServiceCategory are |
| | specified by the ServiceCategoryCS |
| | (urn:mpeg:mpeg-ud:cs:2014:01-SD- |
| | NS:serviceCategoryCS). |
| SupportedFormat | Describes media formats of products |
| | provided or consumed by the service. |

Moreover, the service description includes FormatType. FormatType specifies media formats supported by the service. All the media types supported by the service shall be listed with this type. Table 32 below shows the semantics of FormatType.

TABLE 32

| Name | Definition |
|---|---|
| MediaFormat | Describes a media format supported by |
| | the service. |

The semantics of the ServiceTargetInformationType are shown in Table 33.

TABLE 33

| Name | Definition |
|---|---|
| PreferedUserDescriptionInformation | Describes intended user of |
| | the service using a |
| | UserDescriptionType |
| | specified in MPEG-UD. |
| PreferedContextDescriptionInformation | Describes intended context |
| | of the service using a |
| | ContextDescriptionType |
| | specified in MPEG-UD. |
| ServiceTargetModelType | Describes ServiceTargetModel |
| | which has the informational |
| | role of user segmentation. |

ServiceTargetModelType includes information corresponding to a decision making model to describe an intention of a specific service provider. Decision making can be regarded as the cognitive process resulting in the selection of a course of action among several alternative scenarios. Every decision making process produces a final choice which can be an action or an opinion of choice. Each service provider has own domain knowledge about every phase of its business, and need to make distinct strategies to try to develop into a highly profitable business. For this, it might be important for service provider to segment users considering usage data and statistical analysis of user for providing target services.

First of all, an approach is proposed to describe a decision tree to represent the decision making model. As mentioned earlier, the structure of service description is proposed, and the service target description, which is the second part in the service description, is proposed. Since one of the purposes of the recommendation description is to suggest proper service according to the user's intention, the service description describes its service target in its description. In this element, a DecisionModel child element, which includes information about a decision model uniquely made by a specific service provider, is newly defined. The semantics of the ServiceTargetModelType are shown in Table 34.

TABLE 34

| Name | Definition |
|---|---|
| serviceTargetTree | Describes decision tree model representing the |
| | specific target user type. Decision tree model |
| | may be based on a publicly available decision |
| | making model. |
| serviceTargetType | Indicates the specific service target type |
| | related to this decision tree |
| ServiceTargetSet | Describes a set of user-type vocabularies. Only |
| | vocabulary names defined in the declared user |
| | type set of the given element can be used for |
| | representations of Service Target. |

The semantics of the VocabularySetType are shown in Table 35.

TABLE 35

| Name | Definition |
|---|---|
| VocabularyType | Describes a vocabulary of each subscription |
| | level. |
| NameType | Indicates the name of this vocabulary. |
| IdType | Identifier of this vocabulary set. |

ServiceInterfacesType specifies Service Interfaces provided by the service. Table 36 shows the semantics of ServiceInterfacesType.

TABLE 36

| Name | Definition |
|---|---|
| ServiceInterface | Describes each service interface. |

ServiceInterfaceType describes the type the service interface supported by the service using an MPEG-7 Classification Scheme. Terms for the ServiceInterfaceType may be specified by the ServiceInterfaceTypeCS(urn:mpeg:mpeg-ud:cs:2014:01-SD-NS:serviceInterfaceTypeCS). The semantics of the ServiceInterfaceType are shown in Table 37.

TABLE 37

| Name | Definition |
|---|---|
| ServiceInterfaceInformationURI | Designate location (address) of the |
| | service interface information. Service |
| | consumer retrieves information of |
| | service interface with this URI. |
| Description | Description of provided service |
| | interface. |
| RequiredInputData | Required input data for service |
| | utilization. |

Moreover, the service description includes RequiredInputDataType. RequiredInputDataType specifies what kind of input data is needed to utilize the service. The semantics of RequiredInputDataType are shown in Table 38.

TABLE 38

| Name | Definition |
|---|---|
| CompactUD | Describes part of required user description for service |
| | utilization |
| CompactCD | Describes part of required context description for |
| | service utilization |

InternalServicesType lists internal services within a service. Table 39 shows the semantics of InternalServicesType

TABLE 39

| Name | Definition |
|---|---|
| InternalService | Describes each individual service |
| | within a service. |

InternalServiceType specifies each service within a service. The semantics of InternalServiceType are shown in Table 40.

TABLE 40

| Name | Definition |
|---|---|
| InternalServiceType | Type to describe a service within a |
| | service. |
| ServiceUsagePermission | Describes usage permission for object |
| | created by internal service. |
| Service | Describes embedded internal service |
| | using ServiceDescriptionType. |
| ServiceRef | Describes reference of the internal |
| | service that is one of predefined individual |
| | service. |
| ReferenceServiceID | Describes identifier of the predefined |
| | individual service. |
| servicePriority | Describes priority of the internal |
| | service. Value ranges from 0 to 100 and |
| | default value is 50. |

The semantics of LosslessAudioDBType are shown in Table 41.

TABLE 41

| Name | Definition |
|---|---|
| TitleType | Describes the title of lossless audio |
| | on the database |
| SingerType | Describes the signer of lossless audio |
| | on the database |
| AuthorOfMusicType | Describes the author of lossless audio |
| | on the database |
| KindOfMusicType | Describes the kind of lossless audio |
| | on the database |
| KindOfFileformatType | Describes the kind of lossless audio |
| | file format on the database |
| FirstLineOfMusicType | Describes the first line of lossless |
| | audio on the database |
| AccessHistoryOfUserType | Describes the access history of user |
| | on the database |

The semantics of LossyAudioDBType are shown in Table 42.

TABLE 42

| Name | Definition |
|---|---|
| TitleType | Describes the title of lossy audio on |
| | the database |
| KindOfMusicType | Describes the kind of lossy audio on |
| | the database |
| KindOfFileformatType | Describes the kind of lossy audio file |
| | format on the database |
| AccessHistoryOfUserType | Describes the access history of user |
| | access on the database |
| NetworkOfUserType | Describes the network environment |
| | of user on the database |

The semantics of VideoDBType are shown in Table 43.

TABLE 43

| Name | Definition |
|---|---|
| TypeOfMovie | Describes the type of |
| | video on the database |
| RatingOfVideoType | Describes the rating of |
| | video on the database |
| XSizeOfVideoType | Describes the X-axis |
| | size of video on the database |
| YSizeOfVideoType | Describes the Y-axis |
| | size of video on the database |
| FirstReleasedYearType | Describes the first |
| | released year of video on the |
| | database |
| OriginalLanguageType | Describes the original |
| | language of video on the |
| | database |

The semantics of ServiceObjectType are shown in Table 44 below.

TABLE 44

| Name | Definition |
|---|---|
| ServiceObjectInformationType | Describes the Information of the |
| | objects provided by the service, in |
| | case they are not digital items. |
| DatabaseOfMultimediaType | Describes the digital items provided |
| | by service. |
| DatabaseOfMultimediaType | Information about creation metadata |
| | of the recommended digital item, |
| | expressed using MPEG-7 CreationType. |
| AVSegmentType | A moving region or an audiovisual |
| | segment of the recommended digital |
| | item. To be used in case the |
| | recommended Digital Item is an |
| | audiovisual object. |

The semantics of ObjectType are shown in Table 45.

TABLE 45

| Name | Definition |
|---|---|
| ObjectIDType | Describes the ID of the objects. |
| ObjectNameType | Describes the Name of the objects. |
| ObjectActivityType | Describes the activity of the object. |
| ObjectInformationURIType | Describes the information |
| | associated with the object. |
| ObjectLocationType | Describes the Location of object. |
| ObjectFormatType | Type for the media formats of the |
| | objects. |

The context description providing unit 150 stores the context description and provides the context description to the recommendation engine 120. The context description is information describing the current environment in which the user is situated.

The context description includes ContextDescriptionType, ContextIdentificationType, DeviceCharacteristicsType, NewworkInfoType, LocationType, WeatherType, OtherEnvironmentalInfoType, AudioEnvironment, RecordingEnvironmentType and ContextPriorityType.

The semantics of ContextDescriptionType are shown in Table 46 below.

TABLE 46

| Name | Definition |
|---|---|
| ValidTimeDurationType | Describes valid time duration for |
| | context description. |
| SeasonType | Specifies current season when a |
| | service is requested. |
| DeviceCharacteristicsType | Describes general characteristics |
| | of the terminal. |
| NetworkInfoType | Describes network related |
| | information. |
| LocationType | Describes current location when |
| | a service is requested. The syntax and |
| | semantics of PlaceType are specified in |
| | ISO/IEC 15938-5. |
| WeatherType | Describes current weather when a |
| | service is requested. |
| OtherEnvironmentalInfoType | Describes environmental |
| | information of noise or illumination |
| | characteristics around user. |
| commonAttributesType | Describes a group of attributes |
| | for the CommonAttributes. The syntax |
| | and semantics of commonAttributes are |
| | identical with Common Type of the |
| | MPEG standard. |
| PriorityType | Describes the priority of the |
| | context description |
| OtherContextInfoType | A placeholder for other context - |
| | related information outside the standard |
| | namespace |

The semantics of ContextIdentificationType are shown in Table 47.

TABLE 47

| Name | Definition |
|---|---|
| InstanceIdentifier | Describes ID of the Context |
| sessionIDType | Describes the session ID used by |
| | the Context |

The semantics of DeviceCharacteristicsType are shown in Table 48.

TABLE 48

| Name | Definition |
|---|---|
| DeviceCapability | Describes the capabilities of the |
| | terminal in terms of input-output |
| | capabilities and device properties. |
| | DeviceCapability may include |
| | TerminalCapabilityBaseType, of which |
| | the syntax and semantics are specified |
| | in ISO/IEC 21000-7. |
| SensorDeviceCapabilityListType | Describes the sensor capability of |
| | built-in device. |
| NetworkInterfaceUnit | Describes device's network unit. |
| | NetworkInterfaceUnit may include |
| | NetworkCapabilityType, of which the |
| | syntax and semantics are specified in |
| | ISO/IEC 21000-7. |
| DeviceLocationType | Describes the location of the |
| | device. |
| deviceIDType | Specifies the unique device |
| | identifier. |
| Availability | Specifies availability of device. |
| inUseType | Specifies whether device is |
| | currently in use. |
| operatingSystemType | Describes the operating system |
| | used by the device |
| VersionType | Describes the version of the |
| | operating system/device |

NetworkInfoType describes the static and dynamic information of the available network around user. The semantics of NetworkInfoType are shown in Table 49.

TABLE 49

| Name | Definition |
|---|---|
| NetworkCapabilityType | Describes static information of |
| | network around user. The syntax and |
| | semantics of NetworkCapabilityType are |
| | specified in ISO/IEC 21000-7. |
| NetworkConditionType | Describes dynamic information for |
| | network around user. The syntax and |
| | semantics of NetworkConditionType are |
| | specified in ISO/IEC 21000-7. |
| NetworkedType | Specifies the unique network |
| | identifier. |
| InUseType | Specifies whether device is |
| | currently in use. |

Moreover, the context description includes LocationType. The semantics of LocationType are shown in Table 50.

TABLE 50

| Name | Definition |
|---|---|
| LocationType | Describes user's geographical |
| | location. |
| SemanticLocationType | Describes the semantic location |
| | of the user. |

WeatherType include Temperature, Precipitation, wind and Humidity elements. The semantics of WeatherType are shown in Table 51.

TABLE 51

| Name | Definition |
|---|---|
| TemperatureType | Describes the temperature. May be |
| | described with TemperatureSensorType, of |
| | which the syntax and semantics are |
| | specified in ISO/IEC 23005-5. |
| PrecipitationType | Describes the precipitation during |
| | the specified period of time as defined by |
| | the duration attribute in the default unit of |
| | millimeter or in the unit specified by the |
| | valueUnit attribute. |
| ValueType | Specifies the precipitation in the |
| | default unit of millimeter or in the unit |
| | specified by the valueUnit attribute. |
| valueUnitType | Specifies the unit of the |
| | precipitation value, if a unit other than the |
| | default unit is used, as a reference to a |
| | classification scheme term provided by |
| | UnitTypeCS defined in A.2.1 of ISO/IEC |
| | 23005-6 using the |
| | mpeg7:termReferenceType defined in 7.6 of |
| | ISO/IEC 15938-5. |
| DurationType | Specifies the time period up to the |
| | time of measuring the precipitation in the |
| | default unit of hour or in the unit specified |
| | by durationUnit attribute. |
| durationUnitType | Specifies the unit of the duration, if |
| | a unit other than the default unit is used, as a |
| | reference to a classification scheme term |
| | provided by UnitTypeCS defined in A.2.1 |
| | of ISO/IEC 23005-6 using the |
| | mpeg7:termReferenceType defined in 7.6 of |
| | ISO/IEC 15938-5. |
| Formation | Specifies the formation of the |
| | precipitation. |
| WindType | Describes the strength and the |
| | direction of the wind. The syntax and |
| | semantics of VelocitySensorType are |
| | specified in ISO/IEC 23005-5 |
| DirectionType | Specifies the direction of the wind |
| | coming from, as a reference to a |
| | classification scheme term provided by |
| | WindDirectionTypeCS defined in Annex |
| | B.8 using the mpeg7:termReferenceType |
| | defined in 7.6 of ISO/IEC 15938-5. |
| HumidityType | Describes the humidity. The syntax |
| | and semantics of HumiditySensorType are |
| | specified in ISO/IEC 23005-5. |

The semantics of OtherEnvironmentalInfoType are shown in Table 52.

TABLE 52

| Name | Definition |
|---|---|
| AudioEnvironmentType | Describes the user's audio |
| | environment. |
| IlluminationCharacteristicsType | Describes the overall illumination |
| | characteristics of the natural |
| | environment. The syntax and semantics |
| | of IlluminationCharacteristicsType are |
| | specified in ISO/IEC 21000-7. |

The semantics of AudioEnvironmentType are shown in Table 53.

TABLE 53

| Name | Definition |
|---|---|
| RecordingEnvironmentType | Describes the Recording audio |
| | environment of a particular User. |
| ListeningEnvironmentType | Describes the Listening audio |
| | environment of a particular User. |

The semantics of RecordingEnvironmentType are shown in Table 54.

TABLE 54

| Name | Definition |
|---|---|
| HowlingLevelType | Indicates the Howling level |
| | measured as SPL in dB for a microphone |
| | of the terminal. |
| NumberOfMicType | Indicates the integer parameter |
| | for the number of microphones. |

The semantics of ContextPriorityType are shown in Table 55.

TABLE 55

| Name | Definition |
|---|---|
| ContextIDType | Indicates ID of the context. |
| PriorityType | Describes the priority of the |
| | context description. |

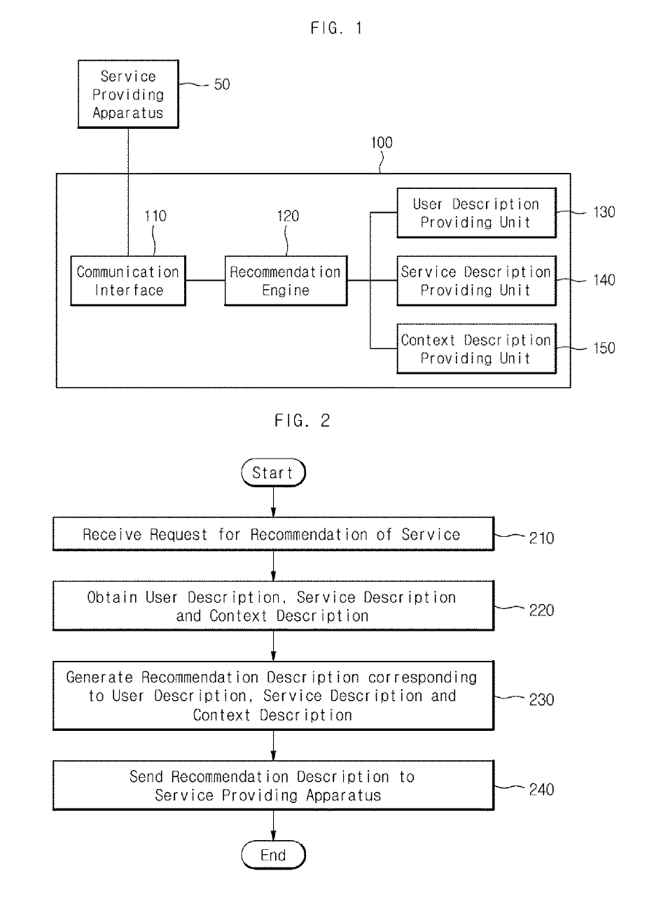

FIG. 2 is a flow diagram showing how the apparatus for recommending a service recommends a service in accordance with an embodiment of the present invention. Although the steps described below are performed by their respective functional units, which constitute the apparatus 100 for recommending a service, these functional units will be collectively referred to as the apparatus 100 for recommending a service for the convenience of description and understanding.

Referring to FIG. 2, in step 210, the apparatus 100 for recommending a service receives a request for recommendation of a service from the service providing apparatus 50.

In step 220, the apparatus 100 for recommending a service obtains a user description, a service description and a context description corresponding to the request for recommendation of a service. For example, the apparatus 100 for recommending a service may request the user description providing unit 130, the service description providing unit 140 and the context description providing unit 150 for the user description, the service description and the context description, respectively, and obtain the user description, the service description and the context description, respectively. Here, the user description may includeUserProfileType, PersonProfileType, OrganizationProfileType, DeviceProfileType, GroupedProfileType, UsageHistoryTyp, EventType, interactionAtomType, artefactType, observableType, multimediaExperienceType, stateType, PreferenceType, WebLinkPreferenceType, ServicePreferencesType, AudioPresentationPreferencesInfoType, TranslationPreferencesType, EmotionType, VocabularySetType, EmotionGroupType, ScheduleType, ScheduleEventType, ActivityType, IntentionType, LanguageType, LanguageCompetenceReferenceType, CompetenceLevelType, SpecialtyType, AccessibilityType, SocialInformationType and ObjectSharingType.

In step 230, the apparatus 100 for recommending a service generates a recommendation description corresponding to the user description, the service description and the context description. For example, the apparatus 100 for recommending a service may generate the recommendation description based on a pattern available in the MPEG-UD standard and the like.

In step 240, the apparatus 100 for recommending a service sends the recommendation description to the service providing apparatus 50. Therefore, the service providing apparatus 50 may provide a service that is suitable for the user by referring to the recommendation description.

The apparatus 100 for recommending a service in accordance with an embodiment of the present invention may be implemented in a computer system.

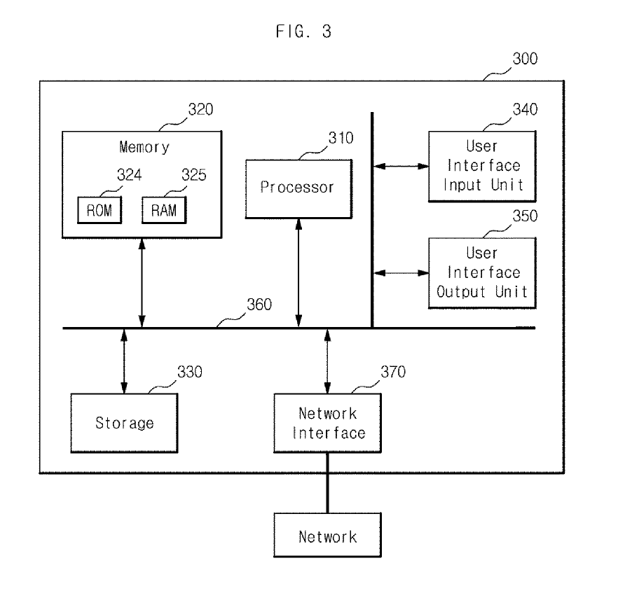

FIG. 3 illustrates the computer system implemented with the apparatus for recommending a service in accordance with an embodiment of the present invention.

An embodiment of the present invention may be implemented as, for example, a computer-readable recording medium, in a computer system. As shown in FIG. 3, a computer system 300 may include one or more of a processor 310, a memory 320, a storage 330, a user interface input unit 340, and a user interface output unit 350, each of which communicates through a bus 360. The computer system 300 may also include a network interface 370 that is coupled to a network. The processor 310 may be a central processing unit (CPU) or a semiconductor device that executes processing instructions stored in the memory 320 and/or the storage 330. The memory 320 and the storage 330 may include various forms of volatile or non-volatile storage media. For example, the memory may include a read-only memory (ROM) 324 and a random access memory (RAM) 325.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. An apparatus for recommending a service, comprising:
a user description providing unit configured for storing a user description;
a communication interface configured for receiving a request for recommendation of a service; and
a recommendation engine configured for obtaining the user description corresponding to the request for recommendation of a service from the user description providing unit and generating a recommendation description by referring to the user description,
wherein the user description comprises at least one of UserProfileType, PersonProfileType, OrganizationProfileType, DeviceProfileType, GroupedProfileType, UsageHistoryTyp, EventType, interactionAtomType, artefactType, observableType, stateType, PreferenceType, EmotionType, VocabularySetType, ScheduleType, ActivityType, IntentionType, LanguageType, SpecialtyType, AccessibilityType, SocialInformationType and ObjectSharingType.

2. The apparatus of claim 1, wherein the UsageHistoryType comprises multimediaExperienceType and DetailedUserInteractionType.

3. The apparatus of claim 1, wherein the PreferenceType comprises at least one of AudioPresentationPreferencesType, DisplayPresentationPreferencesType, GraphicsPresentationPreferencesType, ServicePreferenceType, AudioPresentationPreferencesInfoType, TranslationPreferenceType, InterestedMediaType and WebLinkPreferencesType.

4. The apparatus of claim 1, wherein the LanguageType comprises at least one of NameType, CompetenceReferenceType, LanguageRegionType, Type, ReadingLevelType, WritingLevelType, SpeakingLevelType and ListeningLevelType.

5. The apparatus of claim 4, wherein the CompetenceReferenceType comprises CompetenceTestNameType, CompetenceLevelType, CompetenceTestURIType and CompetenceTestDateType.

6. The apparatus of claim 5, wherein the ScheduleType comprises EventType,
wherein the EventType comprises at least one of SharedUser, RecurrenceInfoType, AlarmTimeType, AlarmFormatType and descriptionMethodType.

7. The apparatus of claim 1, further comprising a service description providing unit configured for storing a service description,
wherein the recommendation engine is configured for generating the recommendation description by referring to the service description and the user description corresponding to the request for recommendation of a service, and
wherein the service description comprises at least one of Service General Description, FormatType, ServiceTargetInformationType, ServiceTargetModelType, VocabularySetType, ServiceInterfaceType, RequiredInputDataType, InternalServicesType, InternalServiceType, LosslessAudioDBType, LossyAudioDBType, VideoDBType, ServiceObjectType and ObjectType.

8. The apparatus of claim 1, further comprising a context description providing unit configured for storing a context description,
wherein the recommendation engine is configured for generating the recommendation description by referring to the context description and the user description corresponding to the request for recommendation of a service, and
wherein the context description comprises at least one of ContextDescriptionType, ContextIdentificationType, DeviceCharacteristicsType, NewworkInfoType, LocationType, WeatherType, OtherEnvironmentalInfoType, AudioEnvironment, RecordingEnvironmentType and ContextPriorityType.

9. A method for recommending a service, the service being recommended by an apparatus for recommending a service, the method comprising:
receiving a request for recommendation of a service;
obtaining a user description corresponding to the request for recommendation of a service; and
generating a recommendation description by referring to the user description,
wherein the user description comprises at least one of UserProfileType, PersonProfileType, OrganizationProfileType, DeviceProfileType, GroupedProfileType, UsageHistoryTyp, EventType, interactionAtomType, artefactType, observableType, stateType, PreferenceType, EmotionType, VocabularySetType, ScheduleType, ActivityType, IntentionType, LanguageType, SpecialtyType, AccessibilityType, SocialInformationType and ObjectSharingType.

10. The method of claim 9, wherein the UsageHistoryType comprises multimediaExperienceType and DetailedUserInteractionType.

11. The method of claim 9, wherein the PreferenceType comprises at least one of AudioPresentationPreferencesType, DisplayPresentationPreferencesType, GraphicsPresentationPreferencesType, ServicePreferenceType, AudioPresentationPreferencesInfoType, TranslationPreferenceType, InterestedMediaType and WebLinkPreferencesType.

12. The method of claim 9, wherein the LanguageType comprises at least one of NameType, CompetenceReferenceType, LanguageRegionType, Type, ReadingLevelType, WritingLevelType, SpeakingLevelType and ListeningLevelType.

13. The method of claim 12, wherein the CompetenceReferenceType comprises CompetenceTestNameType, CompetenceLevelType, CompetenceTestURIType and CompetenceTestDateType.

14. The method of claim 14, wherein the ScheduleType comprises EventType,
wherein the EventType comprises at least one of SharedUser, RecurrenceInfoType, AlarmTimeType, AlarmFormatType and descriptionMethodType.

15. The method of claim 9, further comprising obtaining a service description corresponding to the request for recommendation of a service,
wherein in the generating of the recommendation description by referring to the user description, the recommendation description is generated by referring to the user description and the service description, and wherein the service description comprises at least one of Service General Description, FormatType, ServiceTargetInformationType, ServiceTargetModelType, VocabularySetType, ServiceInterfaceType, RequiredInputDataType, InternalServicesType, InternalServiceType, LosslessAudioDBType, LossyAudioDBType, VideoDBType, ServiceObjectType and ObjectType.

16. The method of claim 9, further comprising obtaining a context description corresponding to the request for recommendation of a service,
wherein in the generating of the recommendation description by referring to the user description, the recommendation description is generated by referring to the user description and the context description, and
wherein the context description comprises at least one of ContextDescriptionType, ContextIdentificationType, DeviceCharacteristicsType, NewworkInfoType, LocationType, WeatherType, OtherEnvironmentalInfoType, AudioEnvironment, RecordingEnvironmentType and ContextPriorityType.
